(19) United States
(12) Patent Application Publication
(10) Pub. No.: US 2002/0069493 A1
(43) Pub. Date: Jun. 13, 2002

(54) Apparatus for positioning a parked vehicle

(76) Inventor: Steve Shepherd, Dallas, TX (US)

Correspondence Address: Gardere Wynne Sewell, LLP, 3000 Thanksgiving Tower,, 1601 Elm Street, Suite 3000, Dallas, TX, 75201-4767, US

(21) Appl. No.: 09/734,419

(22) Filed: Dec. 11, 2000

(51) Int. Cl. A44B 18/00; B60S 13/00

(52) U.S. Cl. 24/306

(57) ABSTRACT

A device for positioning a vehicle during the parking thereof includes a hangable object and a cord, the cord having a first attachment member for attaching the cord to a overhead object at a desired location on the overhead object, and a second attachment member for attaching the hangable object to the cord. In a preferred aspect of this embodiment, the hangable object displays information sufficient to suggest to the user of the identity of an entity.

### FIELD OF THE INVENTION

The present invention relates to methods and apparatus for assisting in correctly positioning a vehicle during a parking operation. In particular, it relates to an improved position detector for parking a vehicle.

### BACKGROUND OF THE INVENTION

In the parking of vehicles, particularly in garages, there is often difficulty in determining the correct parking position. That is, the vehicle must be positioned far forward enough into the garage to leave sufficient clearance behind the vehicle for the garage door to close, and not so far forward as to strike the front wall or other objects in front of the vehicle, such as a work bench, etc.

In the past, persons have improvised various devices for assisting in positioning the vehicle during parking. One such improvised device that has been used is an old tennis ball with a string through it. The old tennis ball is then hung from a rafter in the garage near a position that will cause it to hit the windshield of the vehicle at the position that the vehicle should be stopped. Although using an old tennis ball on a string is an improvement over simply attempting to guess the correct position by eye, this method leaves much to be desired. First of all, many potential users are unaware of how to improvise such a device for positioning a car and have limited mechanical abilities. Where a potential user is aware how to improvise such a device, the user often has no old tennis balls available, and a new tennis ball is expensive. Further, there is often no rafter in the correct position to attach the string to and, where there is a rafter available, it is often too high for the user to conveniently reach to attach the string.

A further, though, related problem of the user often encountered during the parking operation is that the user who parks the vehicle is often in need of various reminders. For example, vehicles are often parked in a garage near the end of the working day, just before mealtime. Since the user must look at the position detecting device during the parking operation, it would be desirable to have information or other suggestions for meals or restaurants printed or otherwise indicated on the positioning device to remind the user of specific alternatives, such as a particular restaurant and/or the telephone number thereof. Other information useful to the user at this point might be a reminder about something relating to the vehicle, such as the need for regular oil changes and a particular favorite shop for doing so, a reminder to check the gasoline gauge and the name of a favorite gas station. A user may also wish to be reminded of a favored sports team or television or movie character.

### OBJECTS OF THE INVENTION

Accordingly, it a present object of the present invention to provide a device and method for positioning a vehicle during the parking thereof that overcomes the foregoing disadvantages.

In particular, it is an object of the present invention to provide a system for positioning a parked vehicle that can be immediately understood and used by persons with little or no capability for improvising devices.

Further, it is an object of the present invention to provide a device for positioning a vehicle that is easier to install in a garage than prior improvised systems.

Further, it is an object of the present invention to provide a system for position a vehicle that does not require the availability of salvaged materials or the inefficient use of new materials not intended for use in positioning a vehicle.

Further, it is an object of the present invention to provide a device for positioning a vehicle that is inexpensive and may be made in a variety of shapes.

Further, it is an object of the present invention to provide a device for positioning a vehicle that has a surface texture that is adapted for receiving ink, paint or other printable matter thereon to serve as a source of information to the user, such as advertising.

### SUMMARY OF THE INVENTION

These objects are accomplished in accordance with a preferred embodiment of the present invention, wherein a device for positioning a vehicle during the parking thereof includes a cord, a first means for attaching the cord to a overhead object at a desired location thereof, a hangable object, and a second means for attaching said hangable object to said cord.

In accordance with another aspect of this embodiment, the first means for attachment includes an adhesive-loaded pad.

In accordance with another aspect of this embodiment, the first means for attachment includes a mechanical insertion device.

In accordance with another aspect of this embodiment, the first means for attachment includes a hook and loop type fastener.

In accordance with another aspect of this embodiment, the hangable object is made from a foam material having a density less than approximately 0.3 per cubic inch.

In accordance with another aspect of this embodiment, said hangable object has a substantially three-dimensional shape and occupies an approximate volume, the weight of said hangable object divided by said approximate volume being less than about 0.3 ounces per cubic inch.

In accordance with another aspect of this embodiment, said hangable object displays information sufficient to remind the user of the identity of an entity.

In accordance with another aspect of this embodiment, said information is embodied in the shape of the hangable object.

In accordance with another aspect of this embodiment, said information is embodied in the coloration of the hangable object.

In accordance with another aspect of this embodiment, said display of information is embodied in the coloration and shape of the hangable object.

In accordance with another aspect of this embodiment, said hangable object has a surface adapted to receive printing materials taken from the group of paint, toner or ink.

In accordance with another aspect of this embodiment, said information is embodied in intelligible material printed on a surface of said hangable object.

### BRIEF DESCRIPTION OF THE DRAWINGS

These and other features and advantages of the present invention will be apparent to those of ordinary skill in the art upon review of the description and drawings herein, in which:

FIG. 1 is an elevation view of one embodiment of the invention suspended from a rafter in a garage, in use positioning a vehicle during a parking operation;

FIG. 2 is an enlarged elevation view of the embodiment of the invention depicted in FIG. 1;

FIG. 3 is an enlarged perspective view of another embodiment of the hangable object of the invention;

FIG. 4 is an enlarged perspective view of an embodiment of the means for attaching the cord to an overhead object, including an insertion device;

FIG. 5 is an enlarged perspective view of an embodiment of the means for attaching the cord to an overhead object, including a mating one of a pair of hook and loop type fasteners attached to the cord and the other mating one of the pair being adhesive-loaded on a back side thereof for attachment to an overhead object;

FIG. 6 is an enlarge perspective view of an embodiment of the means for attaching the cord to an overhead object, including an adhesive-loaded pad for attachment to an overhead object;

### DETAILED DESCRIPTION OF THE PREFERRED EMBODIMENT

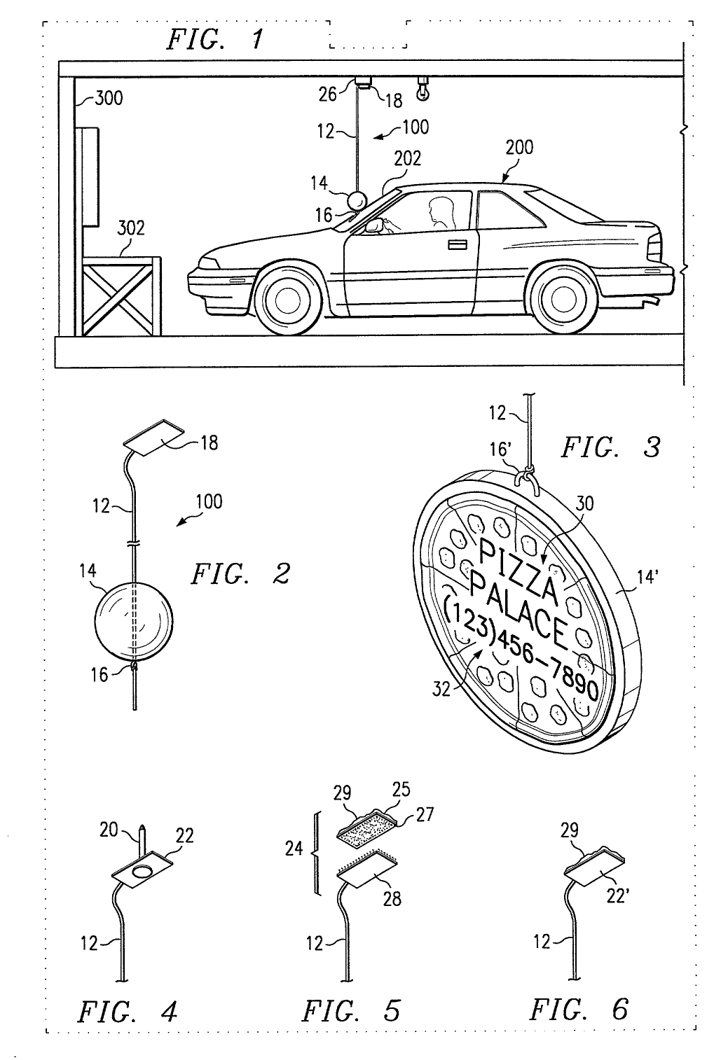

Referring to the drawings in detail, and initially to FIG. 1 thereof, a device 100 for assisting in the positioning of a vehicle 200 during the parking thereof is depicted. Device 100 includes a cord 12, a hangable object 14, a means 16 for attaching the cord to the hangable object 14, and a means 18 for attaching the other end of cord 12 to an overhead object, such as a ceiling or a rafter 26. Cord 12 is preferably a string or yarn comprised of fiber material, but may also be an extruded plastic material, a lightweight chain or the like. It is preferred that that cord 12 is relatively flexible as to remain relatively straight when the hangable object 14 is suspended therefrom it. As depicted in FIG. 1, when the windshield 202 of the vehicle 200 strikes the hangable object 14, it indicated that vehicle 200 is properly positioned. This assists the user in driving the vehicle 200 far enough into the garage to avoid the garage door (not shown), but while leaving the desired clearance from wall 300 or workbench 302.

Referring now to FIGS. 2 and 3, alternative embodiments of the hangable object and attachment means are depicted. As depicted in FIG. 2, cord 12 preferably extends through object 14. Alternately, as depicted in FIG. 3, the cord 12 may be attached to the top of object 14′ (which, in this exemplary embodiment, is in the shape of a pizza) on attachment 16′. Attachment means 16 or 16′ can be any convenient device for attaching the cord 12 to the hangable object 14, such as knot 17 in the cord, glue, melted plastic, a screw, a clip, a pin or the like on the cord may be used. Alternatively, as depicted in FIG. 3, a loop 16′ on the hangable object 14, may be provided. Indeed, where cord 12 extends through object 14, friction between cord 12 and object 14 may serve as sufficient attachment, without need for further means for attachment. Preferably, the attachment means 16 permits ready adjustment of the length of cord 12 above the object, to permit ready adjustment of the suspended height of hangable object 14.

Referring now to FIG. 4, the attachment means at the upper end of cord 12 for attaching the cord 12 to an overhead object, such as a ceiling or rafter can conveniently include an insertion-type attachment member 20, such as a toggle bolt, thumbtack, nail, staple or the like extending through a pad 22. Of course, insertion-type attachment member 20 is attached to the overhead object by pounding, pressing, or screwing it into the overhead object, in well-known manners.

As another alternative to use of a sharp attachment member 20, an attachment pad 22′ including a layer of adhesive 29, as depicted in FIG. 6, may be used.

As depicted in FIG. 5, in order to facilitate attaching means 18 to the overhead object, means 18 preferably includes a pair 24 of hook and loop type fasteners (such as VELCRO). In this way, mating element 27 of the mating pair 24 of the hook and loop type fasteners can be attached alone to the overhead object (without need to preadjust the length of cord 12, for example). Then, the other mating element 28 of the pair 24 of the hook and loop type fasteners (which remains attached to the cord 12) can be easily attached to the already-positioned mating element 27, either by the user standing on a ladder or by remote placement using a stick, for example. This minimizes the time that a user must spend at an elevated height, on a ladder, chair or the like, thus maximizing safety. Conveniently, the mating element 27 can include a sharp attachment member 20, as depicted in FIG. 4. Alternatively, as depicted in FIG. 5 and FIG. 6, mating element 27 may include a layer of adhesive 29 for attachment to the overhead object.

Preferably, though not necessarily, hangable object 14 has a three-dimensional shape. The hangable object 16 can be made of any convenient material, including foam, plastic, paper, cardboard or the like. Preferrably, where foam is used, the density of the foam is less than approximately 0.03 ounces per cubic inch. Where plastic, paper or card is used for hangable object 14 and it forms a generally three-dimensional shape, the weight of the object 14 divided by the approximate volume occupied by the largest exterior dimensions of the generally three-dimensional shape is less than about 0.06 ounces per cubic inch.

The shape of hangable object 16 can be any two-dimensional or three-dimensional shape, including spheres, ellipsoids, cubes, prisms, triangles, pyramids, etc. In particular, hangable object 14 can desirably be formed in a shape suggesting the identity of an entity or item, such as a commercial provider of a product or service, and/or the product or service provided. For example, as depicted in FIG. 3, hangable object 14′ may be formed in the shape of a pizza and alternatively, or in addition thereto, have the name 30 and/or telephone number 32 of a pizza restaurant printed thereon. As another illustrative example, hangable object 14′ may be shaped as a commonly known trademark or trade-dress shape serving to identify a product or service provider, and/or a word indicating the tradename of the product or service provider. In addition to the use of shape, or alternatively, the hangable object may include coloration suggesting a provider of a product or service, and/or the product or service provided. Additionally, or alternatively, the hangable object may include a surface adapted for receiving printing materials, such as ink, toner or paint, and may have printed matter disposed thereon indicating or suggesting a provider of a product or service, and/or or the product or service provided. This may include, for example, the name and/or telephone number of the provider of the product or service, their hours of operation etc. Alternatively, information displayed by the hangable object 14 (by its shape, coloration or printed materials thereon, etc.) may indicate or suggest a favorite sports team, movie or television character, or the like.

Although various embodiment of the present invention have been described, the invention is not to be limited to only those embodiments. Rather, the scope of the invention is to be determined by the following claims, and by equivalents thereof.

I claim:

1. A device for positioning a vehicle during the parking thereof, comprising a hangable object and a cord, said cord including a first means for attachment of said cord to a overhead object at a desired location on said overhead object, a second means for attachment of said hangable object to said cord.

2. The device defined in claim 1, wherein said first means for attachment includes an adhesive-loaded pad.

3. The device defined in claim 1, wherein said first means for attachment is an insertion-type attachment member.

4. The device defined in claim 1, wherein said first means for attachment includes a hook and loop type fastener.

5. The device defined in claim 1, wherein said hangable object is made from a foam material having a density less than approximately 0.03 per cubic inch.

6. The device defined in claim 1, wherein said hangable object has a substantially three-dimensional shape and occupies an approximate volume, the weight of said hangable object divided by said approximate volume being less than 0.06 ounces per cubic inch.

7. The device defined in claim 1, wherein said hangable object displays information sufficient to suggest to the user of the identity of an entity.

8. The device defined in claim 1, wherein said information is embodied in the shape of the hangable object.

9. The device defined in claim 1, wherein said information is embodied in the coloration of the hangable object.

10. The device defined in claim 1, wherein said display of information is embodied in the coloration and shape of the hangable object.

11. The device defined in claim 7, wherein said hangable object has a surface adapted to receive printing materials taken from the group of paint, toner or ink.

12. The device defined in claim 11, wherein said information is embodied in intelligible material printed on a surface of said hangable object.
